(19) United States
(12) Patent Application Publication
(10) Pub. No.: US 2015/0145468 A1
(43) Pub. Date: May 28, 2015

(54) DEVICE AND CHIP FOR CONTROLLING CHARGING, AND USER TERMINAL

(71) Applicant: Spreadtrum Communications (Shanghai) Co., Ltd., Shanghai (CN)

(72) Inventors: Ji MA, Shanghai (CN); Fuqiang ZHANG, Shanghai (CN)

(21) Appl. No.: 14/512,576

(22) Filed: Oct. 13, 2014

(30) Foreign Application Priority Data
Nov. 27, 2013 (CN) 201310618021.5

(51) Int. Cl. H02J 7/00

(52) U.S. Cl. CPC H02J 7/007; H02J 7/0052
USPC 320/107

(57) ABSTRACT

A device, a system and a chip for controlling charging, and a user terminal are provided. The device for controlling charging includes: a battery detection circuit, a charging control circuit, a charging circuit and a charging interface circuit, wherein the charging circuit is connected with a battery, the battery detection circuit, the charging control circuit and the charging interface circuit respectively; the battery detection circuit is adapted for obtaining a voltage value of the battery; the charging interface circuit is connected with a charging power supply; and the charging control circuit is adapted for transmitting a charging control signal for increasing a charging current of the charging power supply through the charging interface circuit when the battery detection circuit detects that the voltage value of the battery is lower than a preset threshold value. The device for controlling charging can improve charging speed when battery power is low.

### CROSS-REFERENCE TO RELATED APPLICATIONS

The present application claims priority to Chinese patent application No. 201310618021.5, filed on Nov. 27, 2013, and entitled “DEVICE, SYSTEM AND CHIP FOR CONTROLLING CHARGING, AND USER TERMINAL”, the entire disclosure of which is incorporated herein by reference.

### TECHNICAL FIELD

The present disclosure generally relates to charging control technology, and more particularly, to a device, a system and a chip for controlling charging, and a user terminal.

### BACKGROUND

In actual applications, users usually charge their user terminals until batteries are run out. If a user wants to use the terminal just when battery is run out, the battery should be charged to a voltage higher than the start voltage of the user terminal in a short time.

Therefore, a device, a system and a chip for controlling charging, and a user terminal are needed for improving charging speed.

### SUMMARY

The present disclosure provides a device, a system, and a chip for controlling charging and a user terminal to improve charging speed when a battery power is low.

In one embodiment, a device for controlling charging is provided. The device for controlling charging may include: a battery detection circuit, a charging control circuit, a charging circuit and a charging interface circuit, wherein the charging circuit is connected with a battery, the battery detection circuit, the charging control circuit and the charging interface circuit respectively, and is adapted for charging the battery and supplying power to the battery detection circuit, the charging control circuit and the charging interface circuit; the battery detection circuit is connected with the battery, and is adapted for obtaining a voltage value of the battery; the charging interface circuit is connected with a charging power supply; and the charging control circuit is connected with the battery detection circuit and the charging interface circuit respectively, and is adapted for transmitting a charging control signal for increasing a charging current of the charging power supply through the charging interface circuit when the battery detection circuit detects that the voltage value of the battery is lower than a preset threshold value.

In some embodiments, the device for controlling charging further includes a charging detection circuit, which is connected with the charging circuit and the charging interface circuit, and is adapted for obtaining working power supply from the charging circuit, and obtaining a device type of the charging power supply which is connected with the charging interface circuit.

In some embodiments, the charging control circuit is adapted for, when the battery detection circuit detects that the voltage value of the battery is lower than the preset threshold value, transmitting the charging control signal for increasing the charging current of the charging power supply to the charging interface circuit based on the device type of the charging power supply.

In some embodiments, the charging interface circuit is a USB charging interface circuit.

In some embodiments, the charging detection circuit is connected with a data line of the USB charging interface circuit.

In some embodiments, the charging control circuit is connected with a data line of the USB charging interface circuit.

In some embodiments, the charging circuit is connected with a power line of the USB charging interface circuit.

In some embodiments, the preset threshold value is a start voltage of a system.

In one embodiment, a system for controlling charging is provided. The system for controlling charging may include the device for controlling charging as described above, and a charging power supply connected with the device for controlling charging.

In one embodiment, a chip for controlling charging is provided. The chip for controlling charging may include the device for controlling charging as described above.

In one embodiment, a user terminal is provided. The user terminal may include: the device for controlling charging as described above, a battery, a power management device and a processor, wherein the device for controlling charging is connected with the battery, and is adapted for controlling a charging process of the battery; the battery is connected with the power management unit, and is adapted for providing power for the power management device; and the power management device is connected with the processor, and is adapted for managing currents and voltages provided by the battery based on a control signal of the processor.

Embodiments of the present disclosure have following advantages. The charging circuit supplies power for the battery detection circuit, the charging control circuit and the charging interface circuit. Namely, power of internal circuits of the device for controlling charging is supplied by the charging circuit rather than the battery. Therefore, even if the voltage of the battery is lower than a preset threshold value, the device for controlling charging can work properly, and the charging speed can be improved by employing the charging interface circuit to increase the charging current.

### BRIEF DESCRIPTION OF THE DRAWINGS

FIG. 1 schematically illustrates a block diagram of a device for controlling charging according to one embodiment of the present disclosure;

FIG. 2 schematically illustrates a block diagram of a system for controlling charging according to one embodiment of the present disclosure;

FIG. 3 schematically illustrates a block diagram of another system for controlling charging according to another embodiment of the present disclosure; and

FIG. 4 schematically illustrates a block diagram of a user terminal according to one embodiment of the present disclosure.

### DETAILED DESCRIPTION

Inventors of the present disclosure found that, a software system of the user terminal is often used to control charging in the conventional technology. However, in a case of extremely low battery power, the system of the user terminal cannot be started. That is, the software system cannot control charging in this case. Even if users need to use the user terminal immediately, the charging speed cannot be improved before the system is started.

A device for controlling charging is provided in embodiments of the present disclosure. A charging circuit is employed to supply power to the device for controlling charging. That is, the power is supplied by an external charging power supply but not the battery. In this way, even if the power of the battery is extremely low, the device for controlling charging can work properly to improve charging speed, so that the voltage of the battery can reach the start voltage immediately.

In order to clarify the objects, characteristics and advantages of the disclosure, the embodiments of the present disclosure will be described in detail in conjunction with the accompanying drawings.

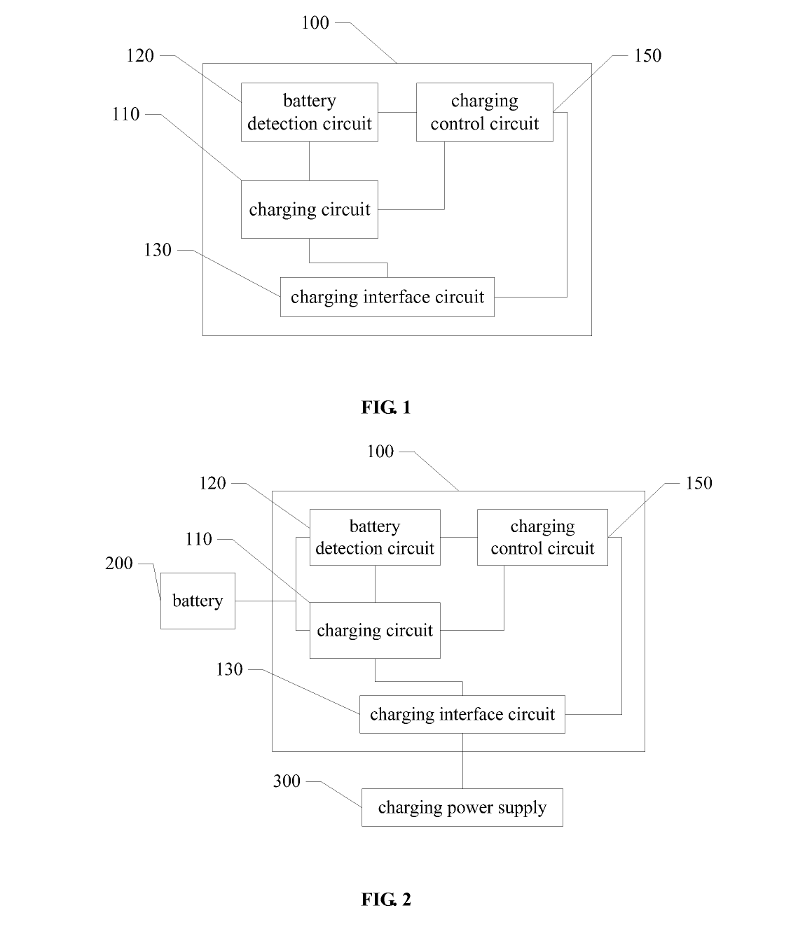

FIG. 1 schematically illustrates a block diagram of a device for controlling charging according to one embodiment of the present disclosure.

Referring to FIG. 1, the device for controlling charging 100 includes a battery detection circuit 120, a charging control circuit 150, a charging circuit 110 and a charging interface circuit 130.

The internal structure of the charging control device will be described in conjunction with a system for controlling charging shown in FIG. 2.

Referring to FIG. 2, in the device for controlling charging 100, the charging circuit 110 is connected with the battery 200 and the charging interface circuit 130 respectively.

In one embodiment, the charging interface circuit 130 may be connected with an external charging power supply 300. As such, by using the external charging power supply 300, the charging circuit 110 can charge the battery 200 through the charging interface circuit 130.

The charging circuit 110 may also be connected with the battery detection circuit 120, the charging control circuit 150 and the charging interface circuit 130, so as to supply power to the battery detection circuit 120, the charging control circuit 150 and the charging interface circuit 130 through the external charging power supply 300.

It should be noted that, the power of the internal circuits (the battery detection circuit 120, the charging control circuit 150 and the charging interface circuit 130) of the device for controlling charging 100 is supplied by the charging circuit 110. The device for controlling charging 100 can work properly even if the voltage of the battery 200 is lower than a preset threshold value. Therefore, the charging interface circuit 130 can increase a charging current to improve the charging speed.

In some embodiments, when the voltage of the battery 200 is equal to or higher than the preset threshold value, the power supply of the internal circuits (the battery detection circuit 120, the charging control circuit 150 and the charging interface circuit 130) of the device for controlling charging 100 may be switched to the battery 200.

Referring to FIG. 2, the battery detection circuit 120 is connected with the battery 200 in order to obtain a voltage value of the battery 200.

The charging control circuit 150 is connected with the battery detection circuit 120 and the charging interface circuit 130 respectively.

In some embodiments, when the battery detection circuit 120 detects that the voltage of the battery 200 is lower than the preset threshold value, the charging control circuit 150 can transmit a charging control signal for increasing the charging current of the external charging power supply 300 through the charging interface circuit 130.

In some embodiments, the charging interface circuit 130 may be a USB charging interface circuit. Specifically, the charging circuit 110 may be connected with a power line of the USB charging interface circuit, so that the charging circuit 110 can be connect with the external charging power supply 300 through the power line, and can charge the battery 200 using the external charging power supply 300.

The charging control circuit 150 may be connected with a data line of the USB charging interface circuit. When the battery detection circuit 120 detects the voltage of the battery 200 is lower than the preset threshold value, the charging control circuit 150 may transmit the charging control signal for increasing the charging current of the external charging power supply 300 through the data line of the USB charging interface circuit. The charging speed can be improved by increasing the charging current.

In some embodiments, the preset threshold value may be a voltage value for starting the system of the user terminal. For example, if the voltage value for starting the system is 2 V, the preset threshold value is 2 V. When the voltage of the battery 200 is lower than 2 V, the charging control circuit 150 may transmit a charging control signal for increasing the charging current of the external charging power supply 300 through the data line of the USB charging interface circuit to improve the charging speed.

In some embodiments, when the preset threshold value is a voltage value for starting the system, and when the battery detection circuit 120 detects the voltage of the battery 200 reaches the preset threshold value, the system can start properly. Thus, the control of battery charging can be transferred from the charging control circuit 150 to software programs of the system. For example, when the voltage value for starting the system is 2 V, the preset threshold value is set as 2 V. If the voltage of the battery 200 is higher than the preset threshold value 2 V, the system can start properly and users can use the system normally. At this time, the software programs of the system can be used to control the charging speed of the battery.

In some embodiments, the preset threshold value may be higher than the voltage value for starting the system. For example, the voltage value for starting the system is 2 V. If the voltage of the battery is 2.5 V at the beginning of charging, which is higher than the voltage value 2 V for starting the system, the system can start properly and users can use the system normally. In this circumstance, by setting the preset threshold value to be higher than the voltage value for starting the system, the charging control circuit 150 can still transmit the charging control signal to increase the charging current of the external charging power supply 300 to improve the charging speed. For example, assuming the preset threshold value is set as 3 V, before the voltage of the battery reaches 3 V, the charging control circuit 150 can be used to transmit the charging control signal for increasing the charging current of the external charging power supply 300 to improve the charging speed. After the voltage of the battery 200 reaches the preset threshold value 3 V, the software programs of the system can be used to control the charging speed of the battery.

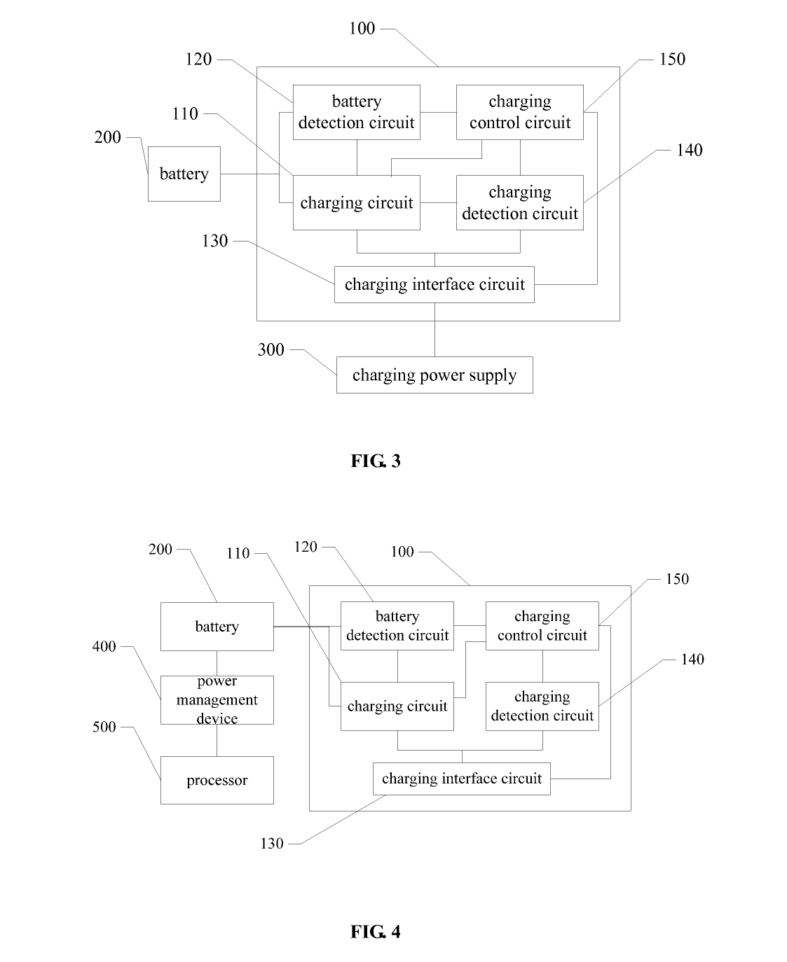

Referring to FIG. 3, in one embodiment of the present disclosure, the device for controlling charging 100 may further include a charging detection circuit 140.

The charging detection circuit 140 may be connected with the charging circuit 110 to obtain working power from the charging circuit 110.

The charging detection circuit 140 may also be connected with the charging interface circuit 130, in order to obtain a device type of the charging power supply 300 connected with the charging interface circuit 130.

As described above, the charging interface circuit 130 is a USB charging interface circuit, so that the charging detection circuit 140 can be connected with the data line of the USB charging interface circuit to obtain charging parameters of the charging power supply 300 and thus to determine device type of the charging power supply 300.

In some embodiments, the charging power supply 300 may be a computer, a mobile power supply, etc.

It should be noted that, in actual applications, different types of charging power supplies have different drive capabilities. That is, ranges of charging currents and charging voltages supplied by the different types of charging power supplies may be different.

Therefore, when the voltage of the battery 200 is lower than the preset threshold value, the charging control circuit 150 transmits the charging control signal to the charging interface circuit 130 based on the device type of the charging power supply 300, in order to increase the charging current of the charging power supply 300.

In some embodiments, the preset threshold value may be the voltage value for starting the system. When the voltage of the battery 200 is lower than the preset threshold value, the system cannot be started. The charging detection circuit 140 can be used to detect the type of the charging power supply 300, and then the charging control circuit 150 can transmit different charging control signals based on the type of the charging power supply 300 in order to improve the charging speed. When the voltage of the battery 200 reaches the preset threshold value, the system can start properly. The charging detection circuit 140 can be used to detect the type of the charging power supply 300, and then the software programs of the system can control the charging process based on the type of the charging power supply 300.

In one embodiment of the present disclosure, a chip for controlling charging is provided. The chip for controlling charging includes the device for controlling charging 100.

In one embodiment of the present disclosure, referring to FIG. 4, a user terminal is provided. The user terminal includes the device for controlling charging 100, the battery 200, a power management device 400 and a processor 500.

Specifically, the device for controlling charging 100 is connected with the battery 200, and is adapted for controlling the charging process of the battery 200. The battery 200 is connected with the power management device 400, and is adapted for providing power for the power management device 400. The power management device 400 is connected with the processor 500, and is adapted for managing currents and voltages provided by the battery 200 based on a control signal of the processor 500.

In some embodiments, the user terminal may be a mobile phone.

It should be understood by those skilled in the art that, a part or all of the steps of the methods in embodiments of this disclosure can be implemented by related hardware under instruction of programs. The programs may be stored in a computer-readable storage medium. The storage medium may include ROM, RAM, magnetic disk, optical disk and etc.

Although the present disclosure has been disclosed above with reference to preferred embodiments thereof, it should be understood by those skilled in the art that various changes may be made without departing from the spirit or scope of the disclosure. Accordingly, the present disclosure is not limited to the embodiments disclosed.

What is claimed is:

1. A device for controlling charging, comprising: a battery detection circuit, a charging control circuit, a charging circuit and a charging interface circuit,
wherein the charging circuit is connected with a battery, the battery detection circuit, the charging control circuit and the charging interface circuit respectively, and is adapted for charging the battery and supplying power to the battery detection circuit, the charging control circuit and the charging interface circuit;
the battery detection circuit is connected with the battery, and is adapted for obtaining a voltage value of the battery;
the charging interface circuit is connected with a charging power supply; and
the charging control circuit is connected with the battery detection circuit and the charging interface circuit respectively, and is adapted for transmitting a charging control signal for increasing a charging current of the charging power supply through the charging interface circuit when the battery detection circuit detects that the voltage value of the battery is lower than a preset threshold value.

2. The device according to claim 1, further comprising: a charging detection circuit, wherein the charging detection circuit is connected with the charging circuit and the charging interface circuit, and is adapted for obtaining working power from the charging circuit, and obtaining a device type of the charging power supply which is connected with the charging interface circuit.

3. The device according to claim 2, wherein the charging control circuit is adapted for, when the battery detection circuit detects that the voltage value of the battery is lower than the preset threshold value, transmitting the charging control signal for increasing the charging current of the charging power supply to the charging interface circuit based on the device type of the charging power supply.

4. The device according to claim 2, wherein the charging interface circuit is a USB charging interface circuit.

5. The device according to claim 4, wherein the charging detection circuit is connected with a data line of the USB charging interface circuit.

6. The device according to claim 4, wherein the charging control circuit is connected with a data line of the USB charging interface circuit.

7. The device according to claim 4, wherein the charging circuit is connected with a power line of the USB charging interface circuit.

8. The device according to claim 1, wherein the preset threshold value is a start voltage value of a system.

9. A chip for controlling charging, comprising: a device for controlling charging,
wherein the device for controlling charging comprises a battery detection circuit, a charging control circuit, a charging circuit and a charging interface circuit;
the charging circuit is connected with a battery, the battery detection circuit, the charging control circuit and the charging interface circuit respectively, and is adapted for charging the battery and supplying power to the battery detection circuit, the charging control circuit and the charging interface circuit;
the battery detection circuit is connected with the battery, and is adapted for obtaining a voltage value of the battery;
the charging interface circuit is connected with a charging power supply; and
the charging control circuit is connected with the battery detection circuit and the charging interface circuit respectively, and is adapted for transmitting a charging control signal for increasing a charging current of the charging power supply through the charging interface circuit when the battery detection circuit detects that the voltage value of the battery is lower than a preset threshold value.

10. The chip according to claim 9, further comprising: a charging detection circuit, wherein the charging detection circuit is connected with the charging circuit and the charging interface circuit, and is adapted for obtaining working power from the charging circuit, and obtaining a device type of the charging power supply which is connected with the charging interface circuit.

11. The chip according to claim 10, wherein the charging control circuit is adapted for, when the battery detection circuit detects that the voltage value of the battery is lower than the preset threshold value, transmitting the charging control signal for increasing the charging current of the charging power supply to the charging interface circuit based on the device type of the charging power supply.

12. The chip according to claim 9, wherein the preset threshold value is a start voltage value of a system.

13. A user terminal, comprising: a device for controlling charging, a battery, a power management device and a processor,
wherein the device for controlling charging comprises a battery detection circuit, a charging control circuit, a charging circuit and a charging interface circuit;
the charging circuit is connected with a battery, the battery detection circuit, the charging control circuit and the charging interface circuit respectively, and is adapted for charging the battery and supplying power to the battery detection circuit, the charging control circuit and the charging interface circuit;
the battery detection circuit is connected with the battery, and is adapted for obtaining a voltage value of the battery;
the charging interface circuit is connected with a charging power supply;
the charging control circuit is connected with the battery detection circuit and the charging interface circuit respectively, and is adapted for transmitting a charging control signal for increasing a charging current of the charging power supply through the charging interface circuit when the battery detection circuit detects that the voltage value of the battery is lower than a preset threshold value;
the device for controlling charging is connected with the battery, and is adapted for controlling a charging process of the battery;
the battery is connected with the power management device, and is adapted for providing power for the power management device; and
the power management device is connected with the processor, and is adapted for managing currents and voltages provided by the battery based on a control signal of the processor.

14. The user terminal according to claim 13, further comprising: a charging detection circuit, wherein the charging detection circuit is connected with the charging circuit and the charging interface circuit, and is adapted for obtaining working power from the charging circuit, and obtaining a device type of the charging power supply which is connected with the charging interface circuit.

15. The user terminal according to claim 14, wherein the charging control circuit is adapted for, when the battery detection circuit detects that the voltage value of the battery is lower than the preset threshold value, transmitting the charging control signal for increasing the charging current of the charging power supply to the charging interface circuit based on the device type of the charging power supply.

16. The user terminal according to claim 14, wherein the charging interface circuit is a USB charging interface circuit.

17. The user terminal according to claim 16, wherein the charging detection circuit is connected with a data line of the USB charging interface circuit.

18. The user terminal according to claim 16, wherein the charging control circuit is connected with a data line of the USB charging interface circuit.

19. The user terminal according to claim 16, wherein the charging circuit is connected with a power line of the USB charging interface circuit.

20. The user terminal according to claim 13, wherein the preset threshold value is a start voltage value of a system.
